(19) United States
(12) Patent Application Publication
(10) Pub. No.: US 2016/0203040 A1
(43) Pub. Date: Jul. 14, 2016

(54) ERROR DISPLAY MODULE

(71) Applicant: HEWLETT-PACKARD DEVELOPMENT COMPANY, L.P., Houston, TX (US)

(72) Inventors: Michael Bozich Calhoun, Roseville, CA (US); Michael Brooks, Roseville, CA (US); Matt Neumann, Roseville, CA (US)

(21) Appl. No.: 14/909,987

(22) PCT Filed: Aug. 29, 2013
(86) PCT No.: PCT/US2013/057225

§ 371 Date: Feb. 4, 2016

(51) Int. Cl. G06F 11/07; G06F 11/00

(52) U.S. Cl. CPC G06F 11/0766; G06F 11/006; G06F 11/073; G06F 2201/805

(57) ABSTRACT

An apparatus is provided to display errors. The apparatus includes an error display module, a memory, and a processor. The error display module to provide a collection of error data. The collection of error data for at least one error from an electronic component. The memory to store a set of instructions. The processor coupled to the memory. The set of instructions instructing the processor to store the collection of error data and display the collection of error data without using power from the electronic component.

### BACKGROUND

Electronic systems typically include error detection architectures. The error detection architecture may be provided by an operating system, a hardware component vendor, and/or written for a specific purpose by the system's original equipment manufacturer (OEM). The error detection architecture monitors the electronic system for errors and failures. The error detection architecture determines when an error occurs and determines whether the error merits action by a user, such as a repair.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale.

Referring to the attached figures:

FIG. 1 illustrates a block diagram of a system to display a collection of error data according to an example;

FIG. 2 illustrates a schematic diagram of the system of FIG. 1 according to an example;

FIG. 3 illustrates a block diagram of a portion of the system of FIG. 1 according to an example:

FIG. 4. Illustrates block diagram of an apparatus according to an example;

FIG. 5 illustrates a flow chart f a method to display a collection of error data according to an example; and

FIG. 6 illustrates a flow chart the method FIG. 5 according o an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Typical error detection architectures store information on failures on the electronic system. The information stored on failures includes, for example, the type of failure and the state of the electronic system. The failure information is stored on the system and only accessible when the system is assembled and powered on.

In examples, an apparatus is provided. The apparatus includes an error display module, a memory, and a processor. The error display module to provide a collection of error data. The collection of error data for at least one error from an electronic component. The memory to store a set of instructions. The processor coupled to the memory. The set of instructions instructing the processor to store the collection of error data and display the collection of error data without using power from the electronic component.

As used herein, the term “error” refers to at least one fault, failure, or error of an electronic component. The term “error” or “errors” may refer to a plurality of faults, failures, or errors that cause the same or distinct errors.

As used herein, the phrase “electronic component” includes a portion of an electronic system, such as a computing system or module. For example, the electronic system may include a server, a storage device, a storage solution, a network solution, and/or a cloud service.

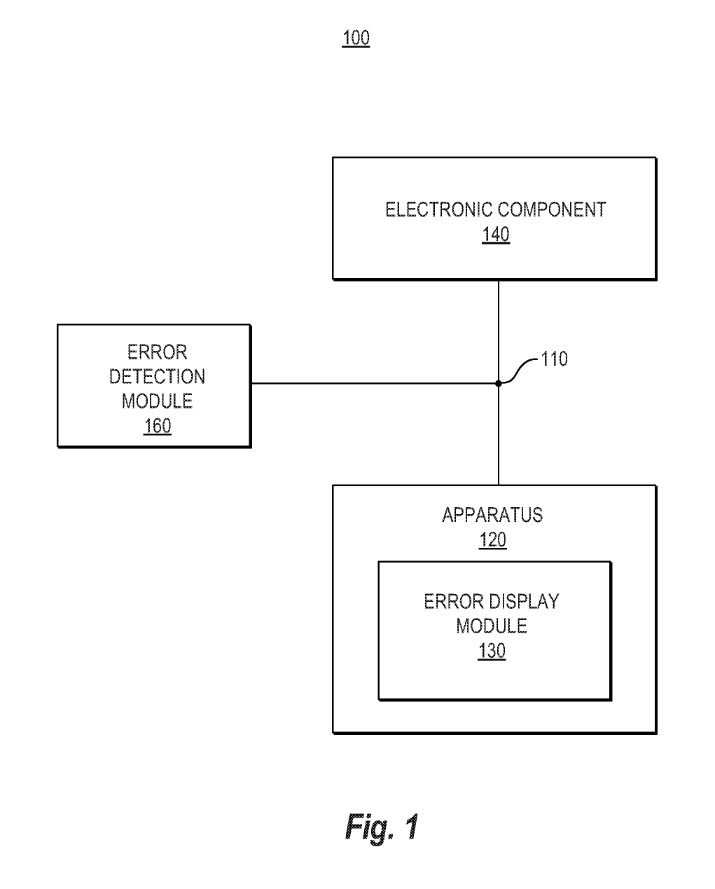

FIG. 1 illustrates a block diagram of a system to display a collection of error data according to an example. The system 100 includes an apparatus 120 with an error display module 130, an electronic component 140, and an error detection module 160. The electronic component 140 may form, for example, a memory module.

The error detection module 160 to monitor the electronic component 140 for an error. For example, the error detection module 160 analyzes the error, such as an intermittent fault in a memory module. The error detection module 160 may also monitor a plurality of intermittent faults and/or determine when a threshold of errors is met. The error detection module 160 then identifies a set of information associated with the error, such as an identification of a portion of the electronic component with a fault, repair instructions, and/or diagnostic data. The error detection module 160 may also provide standard notifications to a user or an associated system. The notifications may be automatically generated based on the error. For example, the error may be detected by a fault module and monitored by the error detection module 160. Alternatively, the error detection module 160 may detect and monitor the error.

The error display module 130 receives a set of information associated with the error from the error detection module 160. The error display module 130 stores the set of information in a memory, such as a non-volatile memory. The error display module 130 then displays a collection of error data. Examples of the collection of error data that may be displayed includes an error, an error code, an error description, a failure message, a set of instructions to repair the error (i.e., a repair instruction), a sequence of actions or instructions provided in a specific or sequential order to correct the error and/or provide visual guidance during the repair, and an identification of the error location or source of the error, such as a visual depiction of the electronic component 140 with errors. The error display module 130 without using power from the electronic component 140 and/or other portions of the system 100, such that the collection of error data to display even when power is removed from the electronic component 140. For example, the error display module 130 may be powered by a battery, a capacitor, and/or a standby power source to provide the display with a power source that is independent of the power supplied to the electronic component. In other words, the functioning of the error display module 130 and the display and/or visual indicators may be visible when the electronic component 140 and/or system connected to the electronic component 140 does not receive power or is not powered on. Another example, includes the use of system power to write the error data using for example, an electronic paper ink, and/or display technologies, such as E Ink®, that changes the state of pixels. For example, when E Ink® is used, the pixels remain in the last state and remain visible when power is removed and without any additional power source.

The display of the collection of error data may provide a visual indicator as a sole display and/or in combination with other displays. The visual indicator represents the error data. The visual indicator is visible even when power is removed from the electronic component. For example, the visual indicator may be a display adjacent to a portion of the electronic component that contains the error, and/or a user interface that displays information and is able to receive input from a user to provide additional error data or displays the error data in a different form. The visual indicator may be powered by a separate power source, such as a battery, or the visual indicator may be powered by a power source in the system 100 or electronic component 140, but remain visible using, for example, electronic paper ink, and/or display technologies.

The apparatus 120, the electronic component 140 and the error detection module 160 communicate via a link 110. The link 110 represents generally one or more of a cable, wireless, fiber optic, and/or remote connections via a telecommunication link, an infrared link, a radio frequency link, or any other connectors or systems that provide electronic communication. The link 110 includes, at least in part, an intranet, the Internet, or a combination of both. The link 110 may also include intermediate proxies, routers, switches, load balancers, and the like.

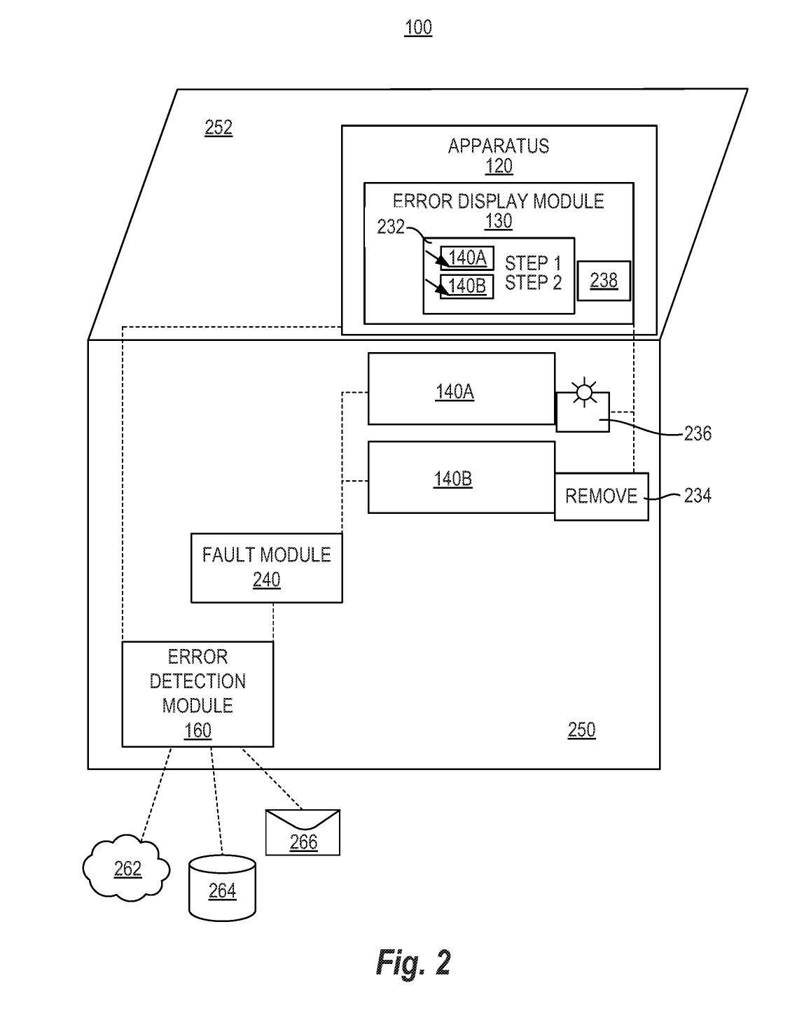

FIG. 2 illustrates a schematic diagram of the system of FIG. 1 according to an example. The system 100 illustrated includes a server 250. The electronic components being monitored are illustrated as memory modules 140A, 140B. For example, the error in the memory module(s) 140A, 140B may include a bit error caused by an intermittent fault. The error data may be displayed using a user interface 232 and/or visual indicators 234, 236. For example, the user interface 232 may include one or a plurality of user interfaces 232 with instructions and/or a picture depicting the electronic component 140 and the portion of the electronic component with an error or a failure. The error may be corrected using repair instructions on the user interface 232, such as steps 1 and 2 and/or a picture of the portion of the electronic component and an arrow pointing to the error location. The memory module(s) 140A, 140B with the error(s) may be located using the visual indicators, such as a display device with an instruction 234, such as “Remove” adjacent to the memory module 140B and/or using a light-emitting diode (LED) light source 236 to identify the memory module 140A with the error(s). The user interface 232, visual indicators 234, 236, and the error display module 130 may be powered by at least one of the following power sources 238 selected from a battery, a capacitor, and a standby power source that is independent of the memory modules' 104A, 140B power source(s). Alternatively, the user interface 232 and/or visual indicators 234, 236 may be powered by the system 100 or electronic components 140 and the user interface 232 and/or visual indicators 234, 236 may remain visible using, for example, electronic paper ink, and/or display technologies.

The visual display may include a display panel, such as a user interface 232 that has an interactive display that receives input and provides output in response to the input. The user interface may be, for example, a display screen and/or a touch-sensitive screen. The display may also offer interactive display elements with a battery that would allow a user to navigate menus, retrieve additional data, update electronic components, and/or send error information to other systems for analysis. The display may provide a dynamic set of documents instead of a traditional static documentation. For example, the display may receive updates and/or current information from the error detection module 160, such that the information stored in the non-volatile memory of the error display module 130 is current or up-to-date. Moreover, this enables the error data to be changed or updated based on updates from a manufacturer or updates based on new software/firmware releases that were installed in the system 100 or electronic component 140.

The display may be in the form of a single visual indicator and/or a combination of visual indicators, for example, on a lid, cover, or air flow baffle 252 of the server and connected to at least one electronic component 140. For example, the visual indicators may include at least one visual indicator to display text 234 and at least one indicator light 236 to indicate a portion of the electronic component having the error. The indicator light may include a light-emitting diode light source that form one or a plurality of visual indicators 234, 236 that represents a portion of the collection of error data. For example, each visual indicator 234, 236 is positioned adjacent to a portion of the electronic component 140, such as electronic components 140A, 140B illustrated in FIG. 2. Each visual indicator 234, 236 may display, for example, an instruction in a sequential order consistent with the repair instruction for the electronic component the visual indicator is positioned adjacent to. A plurality of visual indicators may be further used alone and/or in combination to identify the electronic components to be repaired, such as a specific memory module 140A or 140B with the error. For example, the display module may use a plurality of display methods. In one example, the visual indicators 234, 236 may each include a repair instruction, such as “Remove” 234 to indicate the electronic component 140 to be removed during repair. In another example, the user interface may include repair instructions and the visual indicators may be positioned adjacent to the electronic component corresponding to the instructions to aid with repair, such as color coded lights 235 corresponding to each instruction on a user interface to allow easy identification of which instruction the repair corresponds to.

The error display module 130 receives information about the error from the error detection module 160. The error detection module 160 monitors the electronic component 140 for an error. The monitoring may be performed solely by the error detection module 160 and/or in combination with another module, such as a fault module 240 associated with at least one of the electronic components, such as, memory modules 140A, 140B. The monitoring may include analyzing an error, such as an intermittent fault from a memory module. The analysis of the error may include identification of the cause of the error. The error detection module 160 may also determine a repair instruction and/or a diagnostic solution based on the error. For example, the error detection module 160 may provide instructions to correct the intermittent fault that caused the bit error. The analysis and determination steps may be performed by the error detection module 160 using a query of a database, such as a cloud storage device or the Internet 262, and/or a library or collection of data, such as a data store 264. The cause of the error and/or repair instructions may be received from the database, for example, the error detection module 160 may download the error or repair information from a website and/or copy error data from a library internal or external to the system 100. The information about the error may be static information or dynamic information. For example, the information may be stored in a non-volatile memory that is regularly or on demand retrieves or updated the error data from a remote device, such that the data may be continuously updated to ensure the information corresponding to the error data is current. In an example, the error data may be received from a manufacturer's website or be updated based on software or firmware updates to the system or the electronic components 140. The error detection module 160 may also transmit notifications regarding the error. For example, the notification may be to another machine (i.e., a cloud server or the Internet 262), to a memory device (i.e., a data store 264), and/or to a user via for example an email or other message 266.

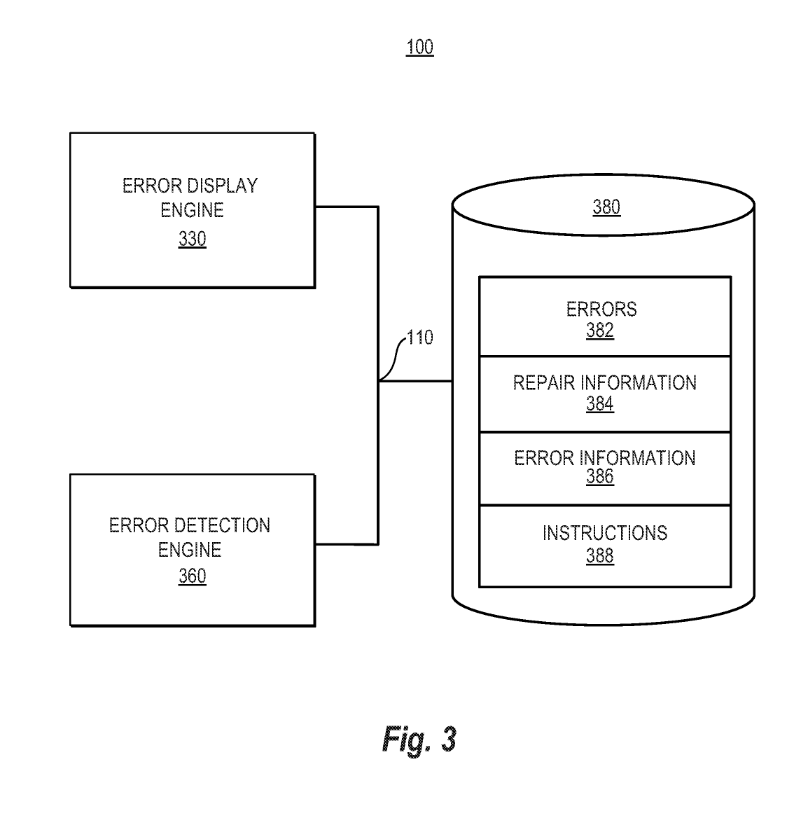

FIG. 3 illustrates a block diagram of a portion of the system of FIG. 1 according to an example. Referring to FIG. 3, the system 100 is illustrated to include an error display engine 330 and an error detection engine 360. The error display engine 330 and the error detection engine 360 are linked 110 to the electronic component 140, as illustrated in FIGS. 1-2. The system 100 is further illustrated to include a data store 380 connected to the error display engine 330 and the error detection engine 360 via the link 110. The error display engine 330 functionalities are accomplished via the link 110 that connects the error display engine 330 to the error detection engine 360 and the data store 380.

The error display engine 330 represents generally a combination of hardware and/or programming that provides an interface between the error detection engine 360 and the electronic component 140 to display a collection of error data. For example, the error display engine 330 communicates with the error detection engine 360 to receive a set of information associated with the error. The error display engine 330 stores the set of information in a memory, such as a non-volatile memory. For example, the error detection engine 360 may write the error to the non-volatile memory.

The error display engine 330 determines or identifies the appropriate signals, response, and/or messages based on the information related to the errors received from the error detection engine 360. The error display engine 330 uses the information related to the errors to display the set of information as a collection of error data. The collection of error data may be displayed by transmitting signals to a display. The collection of error data displayed may be sent as a visual indicator that is visible without power from the electronic component or the system running the electronic component, such that the display and/or error display engine uses a power source independent of the electronic component 140 or the system 100 including the electronic component 140. For example, a user notification that is displayed on a panel or a visual indicator that is powered by a battery or using electronic paper ink, and/or display technologies.

The error detection engine 360 represents generally a combination of hardware and/or programming that interfaces with the error display engine 330. For example, the error detection engine 360 communicates with the error display engine 330 to provide a set of information associated with the error. The error detection engine 360 provides the set of information by monitoring the electronic component 140 for an error. The monitoring may be performed using an error detection architecture that is provided by the operating system, a hardware component vendor, and/or firmware written for the specific purpose by the system's original equipment manufacturer (OEM). The monitoring may include analyzing the error to identify the cause of the error and/or to determine a diagnostic solution based on the error. For example, the error detection module 160 may provide repair instructions. The analysis and determination steps may be performed by the error detection module 160 using the Internet or a data store 380. The error detection engine 360 may also selectively transmit a message related to the error to, for example, a user, a system administrator, a database, and/or the error display engine 330. The functions of the error detection engine 360 to monitor the errors and transmit messages and notifications may be performed as part of an existing mechanism on the system 100.

The error display engine 330 and/or the error detection engine 360 may include additional functionalities, such as the ability to generate notifications related to the information received and/or the error via for example, a notification engine (not illustrated) that represents generally a combination of hardware and/or programming that generates a notification based on at least one of errors 382, the repair information 384, and the error information 386. The notification engine may be a separate engine or incorporated into at least one of the error display engine 330 and/or the error detection engine 360 that may individually or in combination perform the functions that generate the notification.

The notification may be used to allow manual actions, such as a soft shutdown of a system 100 or electronic component 140. The soft shut down, may be performed manually or automatically and to prevent loss of data or abrupt disruption of service. The notification may also be used as a “last resort” as the error display engine 330 and/or the error detection engine 360 receives the error and the notification provides users with a reason for a service disruption or a reference to the event for trouble shooting. The notification may alternatively be a reporting process to monitor and record information relating to the error.

The data store 380 represents generally any memory configured to store data accessible by the error display engine 330 and/or the error detection engine 360 in the performance of its function. The data store 380 is, for example, a database that stores errors 382, repair information 384, error information 386, and instructions 388 to perform the functions of the error display engine 330 and/or the error detection engine 360. For example, the data store 380 may include the non-volatile memory of the error display engine 330.

The set of instructions 388 are executed to store a collection of error data from the error detection module 140 and display the collection of error data. The set of instructions 388 to store the collection of error data may further include instructing the processor to write the collection of error data to the memory of the error display module 130. The collection of error data includes, for example, errors 382, repair information 384, and error information 386. The error 382 may include, for example, an error code and/or an error description. The repair information 384 may include, for example, a repair instruction that includes the steps to repair the error and/or a sequence of instructions to provide guidance during the correction of an error. The error information 386 may include, for example, an identification of an error location, such as a graphical depiction or a visual indicator of a specific electronic component or portion of the electronic component having an error. The collection of error data may further include an error notification that includes, for example, the error 382, repair information 384, and error information 386 that may be sent to a user or another system via a display or transmitted via an electronic message, such as an email or SMS. The errors 382, repair information 384, and/or error information 386 may be maintained or stored in the data store 380 after the errors are corrected to enable analysis of the errors and/or the system over time.

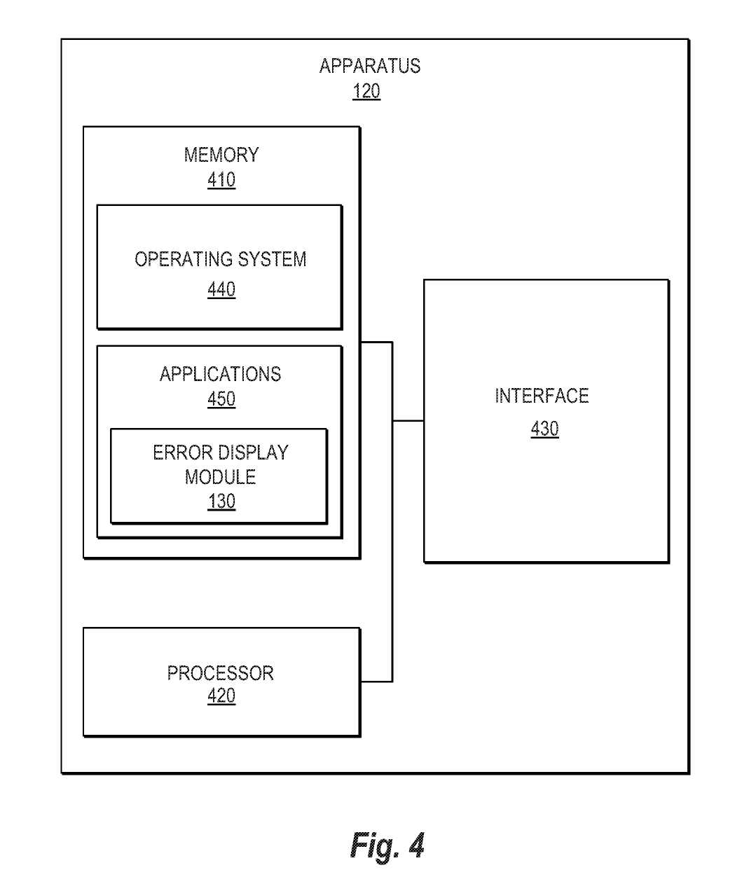

FIG. 4 illustrates a block diagram of an apparatus 120 according to an example. The apparatus 120 includes an error display module 130, a memory 410, and a processor 420. The error display module 130 to provide a collection of error data. The collection of error data for at least one error from an electronic component. The memory 410 to store a set of instructions. The processor 420 is coupled to the memory 410. The set of instructions instructing the processor 420 to store the collection of error data in a memory, such as a non-volatile memory and display the collection of error data without using power from the electronic component. For example, the display may use a power source independent of the electronic component 140 or an electronic paper ink.

Referring to FIG. 4, the apparatus 120, for example, includes firmware or a computer readable medium that interfaces with the error detection module 160. The apparatus 120 is illustrated to include a memory 410, a processor 420, and an interface 430. The memory 410 stores a set of instructions. The processor 420 is coupled to the memory 410 to execute the set of instructions. The processor 420 represents generally any processor configured to execute program instructions stored in memory 410 to perform various specified functions. The interface 430 represents generally any interface enabling the apparatus 120 to interface with the error display module 130, and/or the data store 380 via the link 110, as illustrated in FIGS. 1-3.

The memory 410 is illustrated to include an operating system 440 and applications 450. The operating system 440 represents a collection of programs that when executed by the processor 420 serves as a platform on which applications 450 run. Examples of operating systems 440 include various versions of Microsoft's Windows® and Linux®. Applications 450 represent program instructions that when executed by the processor 420 function as an application that when executed by a processor 420 to provide a collection of error data.

For example, FIG. 4 illustrates an error display module 130 as executable program instructions stored in memory 410 of the apparatus 120. The error display module 130, when executed provides a collection of error data for at least one error from an electronic component. The set of instructions 388 enable the error display module 130 to store the collection of error data in the memory and display the collection of error data without using power from the electronic component. For example, the display may include a user interface that displays a portion of the collection of error data.

Referring back to FIGS. 1-3, the error display engine 330 is described as combinations of hardware and/or programming. As illustrated in FIG. 4, the hardware portions include the processor 420. The programming portions include the operating system 440, applications 450, and/or combinations thereof. For example, the error display module 130 represents program instructions 388 that when executed by a processor 420 cause the implementation of the of the error display engine 330 of FIGS. 1-3.

The programming of the error display module 130 may be processor 420 executable instructions stored on a memory 410 that includes a tangible memory media and the hardware includes a processor 420 to execute the instructions. The memory 410 may store program instructions that when executed by the processor 420 cause the processor 420 to perform the program instructions. The memory 410 is integrated in the same device for system) as the processor 420 or it is separate but accessible to that device (or system) and processor 420.

In examples, the program instructions may be part of an installation package that can be executed by the processor 420 to perform a method using the system 100. The memory 410 is a portable medium such as a CD, DVD, or flash drive or a memory maintained by a server from which the installation package can be downloaded and installed. In other examples, the program instructions may be part of an application or applications already installed on a computing device. In further examples, the memory 410 includes integrated memory, such as a hard drive.

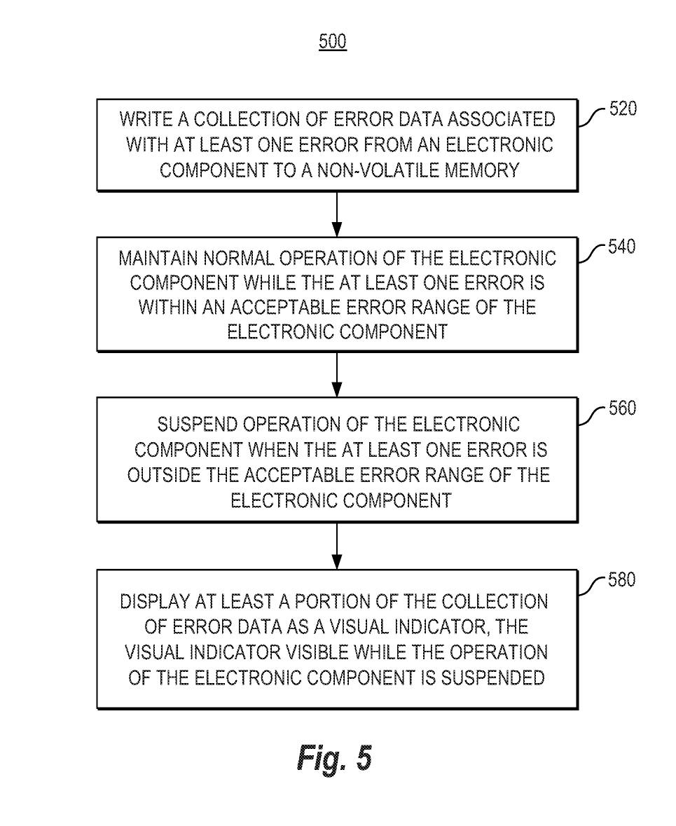

FIG. 5 illustrates a flow chart 500 of a method to display a collection of error data according to an example. In block 520, a collection of error data associated with at least one error from an electronic component is written to a non-volatile memory. The non-volatile memory is associated with an error display module. Normal operation of the electronic component is maintained in block 540 while the at least one error is within an acceptable error range of the electronic component. In block 560, the operation of the electronic component is suspended when the at least one error is within the error threshold or range. At least a portion of the collection of error data is displayed a visual indicator in block 580. The visual indicator is visible while the operation of the electronic component is suspended. For example, the visual indicator includes a power source that is independent of the electronic component to enable the visual indicator to be visible while the operation of the electronic component is suspended. The visual indicator may include, for example, a sequential set of repair instructions to correct the error. The method may further provide the display as an interactive user interface that enables a user to display the collection of error data and receive an input. For example, the display may be determined and/or modified based on the received input.

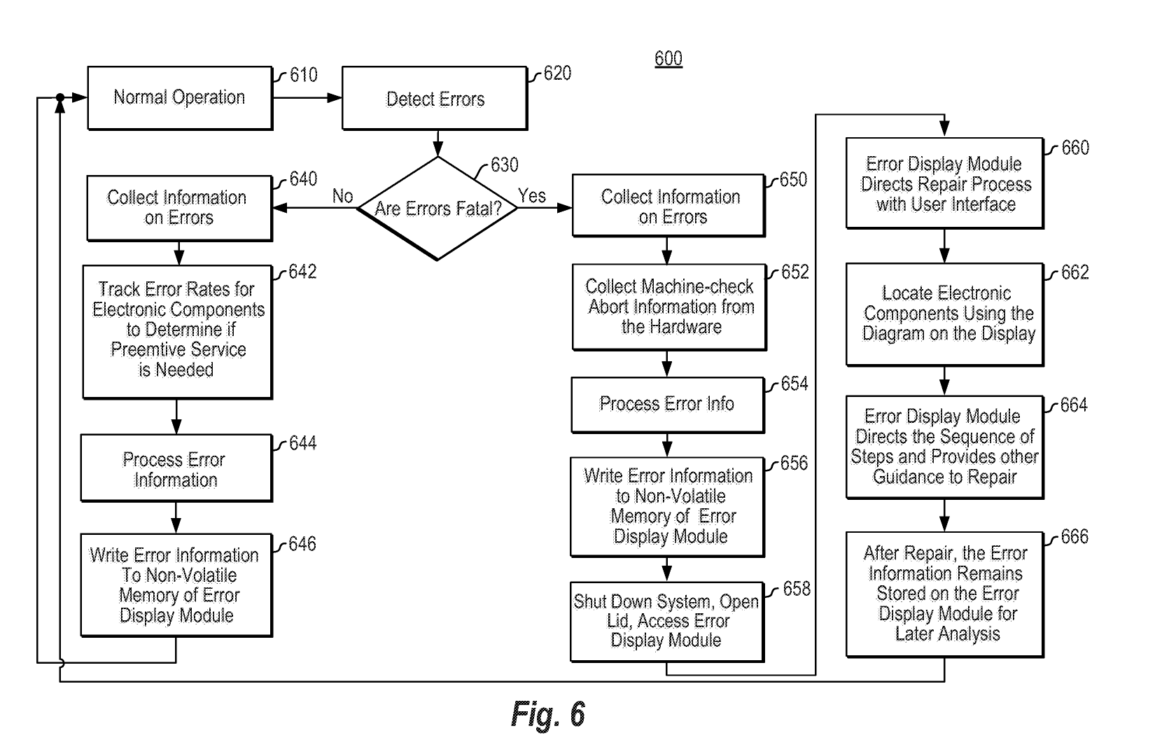

FIG. 6 illustrates a flow chart 600 the method of FIG. 5 according to an example. In block 610, an electronic system with at least one electronic component maintains normal operation until an error is detected by the error detection architecture, in block 620. The error detection architecture may be managed by a management firmware, system firmware, and/or an operating system, for example, through an error detection module. The error detection architecture determines if the error is fatal in block 630. For example, an error is fatal when the probability of non-correctable errors increases to an unacceptable level. When the error(s) remain at an acceptable level, i.e., within an acceptable error range, the error(s) is/are determined not fatal and moves to block 640. Block 640 illustrates that the error detection module collects information on the error and fault that caused the error by, for example, the system firmware. The information on the error may also be sent to the management firmware. The error detection module then tracks the error rates for components and determines if and/or when a preemptive service is needed in block 642. In block 644, the information on the error is processed by the management firmware, which may also retrieve repair instructions and provide a notification to a user of the error. The information on the error is then sent to the error display module in block 646 and written to the non-volatile memory of the error display module. Since the errors were determined not fatal, the system continues normal operation in block 610.

However, when the error detection architecture determines that the error is fatal in block 630, the error detection module, such as the system firmware collects the error information from, for example, the operating system in block 650. The machine-check abort information is collected by, for example, the system firmware, from the hardware in block 652. In block 654, the error information is processed by the management firmware, which also retrieves repair instructions, and notifies the user of the error. The error information is written to the non-volatile memory of the error display module in block 656 and the system is shut down in in block 658. When the system is shut down the lid may be opened or a cartridge removed and the error display module may be viewed and accessed. In block 660, the error display module directs the repair process, using for example, a user interface. The components of the system may be located using, for example, a display panel with a visual indicator associated with the error display module in block 662. The user interface and/or the display panel may direct a user to perform a sequence of steps or provide other guidance in block 664. For example, the user interface and/or the display panel may include a list of repair instructions and/or user interactive menus with repair information or instructions. The error is repaired in block 666 and the error information will remain stored on the error display module for later analysis. The system may then be turned back on and return to normal operation in block 610 and the method may repeat.

Although the flow diagrams of FIG. 5-6 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “Include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. An apparatus comprising:
an error display module to provide a collection of error data, the collection of error data for at least one error from an electronic component;
a memory to store a set of instructions; and
a processor coupled to the memory, the set of instructions instructing the processor to:
store the collection of error data in a non-volatile memory; and
display the collection of error data using a power source independent of a power supply to the electronic component.

2. The apparatus of claim 1, wherein the error display module provides a plurality of visual indicators, each visual indicator positioned adjacent to a portion of the electronic component, each visual indicator to display an instruction in a sequential order consistent with a set of repair instructions for the portion of the electronic component that the visual indicator is positioned adjacent thereto.

3. The apparatus of claim 1, wherein the collection of error data comprises an error description.

4. The apparatus of claim 1, wherein the collection of error data comprises an identification of an error location.

5. The apparatus f claim 1, wherein the collection of error data comprises a repair instruction.

6. The apparatus of claim 1, wherein the error display module includes a user interface.

7. A system comprising:
an electronic component;
an error detection module to monitor the electronic component for an error; and
an error display module to:
receive a set of information associated with the error,
store the set of information in a memory; and
display a collection of error data, the collection of error data to display without using power from the electronic component.

8. The system of claim 7, wherein the error display module is powered by at least one of the following power sources selected from a battery, a capacitor, and a standby power source.

9. The system of claim 7, wherein the set of information is obtained from a remote device.

10. The system of claim 7, wherein the error display module provides an interactive display that receives input and provides output in response to the input.

11. The system of claim 7, wherein the electronic component comprises a memory module and the error comprises a bit error.

12. The system of claim 7, wherein the error display module provides a visual display including at least one visual indicator selected from a display panel and a light-emitting diode light source.

13. A method to display a collection of error data, the method comprising:
writing a collection of error data associated with at least one error from an electronic component to a non-volatile memory;
maintaining normal operation of the electronic component while the at least one error is within an acceptable error range of the electronic component;
suspending operation of the electronic component when the at least one error is outside the acceptable error range of the electronic component; and
displaying at least a portion of the collection of error data as a visual indicator, the visual indicator visible while the operation of the electronic component is suspended.

14. The method of claim 13, further comprising providing an interactive user interface to display the collection of error data and receive an input.

15. The method of claim 13, further comprising displaying the visual indicator as a sequential set of instructions.
